(19) United States
(12) Patent Application Publication
(10) Pub. No.: US 2026/0065104 A1
(43) Pub. Date: Mar. 5, 2026

(54) PARAMETERIZED ARITHMETIC CODING FOR POINT CLOUD ATTRIBUTE COMPRESSION

(71) Applicant: InterDigital VC Holdings, Inc., Wilmington, DE (US)

(72) Inventors: Yuning HUANG, Indianapolis, IN (US); Jiahao PANG, New York, NY (US); Muhammad Asad LODHI, New York, NY (US); Junghyun AHN, New York, NY (US); Dong TIAN, Wilmington, DE (US)

(21) Appl. No.: 18/825,407

(22) Filed: Sep. 5, 2024

(51) Int. Cl. G06N 7/01

(52) U.S. Cl. CPC G06N 7/01

(57) ABSTRACT

In one implementation, a method of encoding or decoding point cloud data is provided, comprising: obtaining a feature map representing attributes of voxels in an octree structure; determining one or more probability distribution parameters for a probability density function associated with an attribute of a current voxel, based on the feature map; determining a probability mass function of the attribute of the current voxel based on the one or more probability distribution parameters for the probability density function for the current voxel; and encoding or decoding attribute information of the current voxel in the octree structure, based on the probability mass function of the attribute for the current voxel.

### INCORPORATION BY REFERENCE

The present application incorporates by reference in its entirety the following application: U.S. patent application Ser. No. 18/814,402, entitled “An End-to-End Learning-based Point Cloud Attribute Coding Framework” (“402 application”).

### BACKGROUND

The present application is related to point cloud compression and processing.

The Point Cloud (PC) data format is a universal data format across several business domains, e.g., from autonomous driving, robotics, augmented reality/virtual reality (AR/VR), civil engineering, computer graphics, to the animation/movie industry. 3D LiDAR (Light Detection and Ranging) sensors have been deployed in self-driving cars, and affordable LiDAR sensors are released from Velodyne Velabit, Apple iPad Pro 2020 and Intel RealSense LiDAR camera L515. With advances in sensing technologies, 3D point cloud data becomes more practical than ever and is expected to be an ultimate enabler in the applications discussed herein.

### BRIEF SUMMARY

Briefly stated, in one embodiment, a method of decoding point cloud data is presented, comprising: obtaining a feature map representing attributes of voxels in an octree structure; determining one or more probability distribution parameters for a probability density function associated with an attribute of a current voxel, based on the feature map; determining a probability mass function of the attribute of the current voxel based on the one or more probability distribution parameters for the probability density function for the current voxel; and decoding attribute information of the current voxel in the octree structure, based on the probability mass function of the attribute for the current voxel.

According to another embodiment, a method of encoding point cloud data is presented, comprising: obtaining a feature map representing attributes of voxels in an octree structure; determining one or more probability distribution parameters for a probability density function associated with an attribute of a current voxel, based on the feature map; determining a probability mass function of the attribute of the current voxel based on the one or more probability distribution parameters for the probability density function for the current voxel; and encoding attribute information of the current voxel in the octree structure, based on the probability mass function of the attribute for the current voxel.

According to another embodiment, an apparatus for decoding point cloud data is presented, comprising one or more processors and at least one memory coupled to the one or more processors, wherein the one or more processors are configured to: obtain a feature map representing attributes of voxels in an octree structure; determine one or more probability distribution parameters for a probability density function associated with an attribute of a current voxel, based on the feature map; determine a probability mass function of the attribute of the current voxel based on the one or more probability distribution parameters for the probability density function for the current voxel; and decode attribute information of the current voxel in the octree structure, based on the probability mass function of the attribute for the current voxel.

According to another embodiment, an apparatus for encoding point cloud data is presented, comprising one or more processors and at least one memory coupled to the one or more processors, wherein the one or more processors are configured to: obtain a feature map representing attributes of voxels in an octree structure; determine one or more probability distribution parameters for a probability density function associated with an attribute of a current voxel, based on the feature map; determine a probability mass function of the attribute of the current voxel based on the one or more probability distribution parameters for the probability density function for the current voxel; and encode attribute information of the current voxel in the octree structure, based on the probability mass function of the attribute for the current voxel.

### BRIEF DESCRIPTION OF THE DRAWINGS

The following detailed description will be better understood when read in conjunction with the appended drawings, in which there are shown examples of one or more of the multiple embodiments of the present disclosure. It should be understood, however, that the embodiments described herein are not limited to the precise arrangements and instrumentalities shown in the drawings. In the drawings:

FIG. 1 illustrates a block diagram of a system within which aspects of the present embodiments may be implemented;

FIG. 2 illustrates voxels in different levels;

FIG. 3 illustrates learned octree-based attribute encoding;

FIG. 4 illustrates learned octree-based attribute decoding;

FIG. 5 illustrates voxels in different levels;

FIG. 6 illustrates octree-based attribute encoding using a learning-based method;

FIG. 7 illustrates octree-based attribute decoding using a learning-based method;

FIG. 8 illustrates a feature aggregator (FA) with only one level as input;

FIG. 9 illustrates a feature encoder using uniform quantization;

FIG. 10 illustrates a feature decoder with de-quantization;

FIG. 11 illustrates the probability estimation and arithmetic encoding process for the encoder;

FIG. 12 illustrates the probability estimation and arithmetic decoding process for the decoder;

FIG. 13 illustrates design of the APE (Attribute Probability Estimator);

FIG. 14 illustrates the probability estimation and arithmetic encoding process for the encoder, according to one embodiment;

FIG. 15 illustrates the probability estimation and arithmetic decoding process for the decoder, according to one embodiment;

FIG. 16 illustrates the design of the ADE (Attribute Distribution Estimator), according to one embodiment; and

FIG. 17 illustrates the process of integrating a probability density function to obtain the probability values.

### DETAILED DESCRIPTION

In describing the various embodiments of the present disclosure, certain terminology is used herein for convenience only and should not be considered as limiting such embodiments. In the drawings, the same reference numerals are employed for designating the same elements throughout the several figures and the present description.

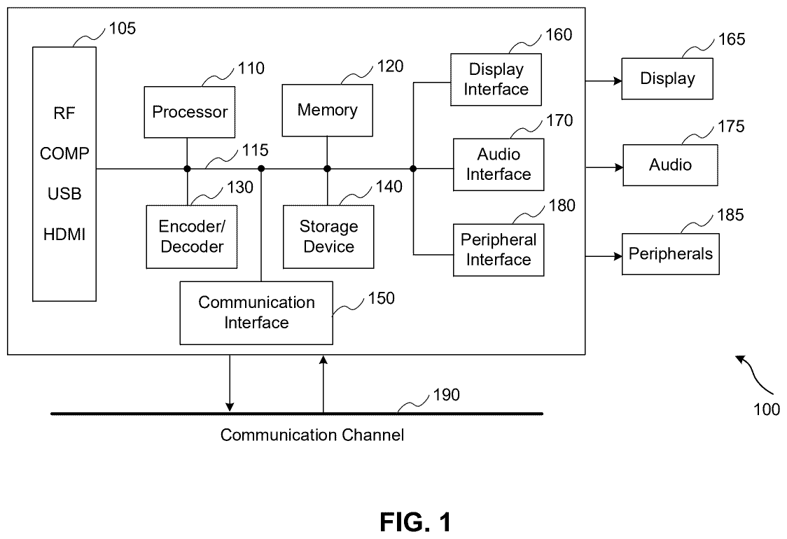

Referring to the drawings, there is shown in FIG. 1 a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In several embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, JPEG Pleno, MPEG-I, HEVC, or VVC.

The input to the elements of system 100 may be provided through various input devices as indicated in block 105. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the datastream as necessary for presentation on an output device.

Various elements of system 100 may be provided within an integrated housing. Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11. The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105.

The system 100 may provide an output signal to various output devices, including a display 165, speakers 175, and other peripheral devices 185. The other peripheral devices 185 include, in various examples of embodiments, one or more of a stand-alone DVR, a disk player, a stereo system, a lighting system, and other devices that provide a function based on the output of the system 100. In various embodiments, control signals are communicated between the system 100 and the display 165, speakers 175, or other peripheral devices 185 using signaling such as AV. Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

### Point Cloud Data Format

Point cloud is a universal data format across several business domains from autonomous driving, robotics, AR/VR, civil engineering, computer graphics, to the animation/movie industry. 3D LiDAR sensors have been deployed in self-driving cars, and affordable LiDAR sensors are released from Velodyne Velabit, Apple ipad Pro 2020 and Intel RealSense LiDAR camera L515. With advances in sensing technologies, 3D point cloud data becomes more practical than ever and is expected to be an ultimate enabler in the applications mentioned.

Point cloud data is also believed to consume a large portion of network traffic, e.g., among connected cars over 5G network, and immersive communications (VR/AR). Efficient representation formats are necessary for point cloud understanding and communication. In particular, raw point cloud data needs to be properly organized and processed for the purposes of world modeling and sensing. Compression on raw point clouds is essential when storage and transmission of the data are required in the related scenarios.

Furthermore, point clouds may represent a sequential scan of the same scene, which contains multiple moving objects. They are called dynamic point clouds as compared to static point clouds captured from a static scene or static objects. Dynamic point clouds are typically organized into frames, with different frames being captured at different times. Dynamic point clouds may require the processing and compression to be in real-time or with low delay.

Each point of the point clouds is represented at least by a 3D position (x, y, z). The set of the 3D positions illustrates the geometry of the object/scene that the point cloud is captured from. Additionally, each point of the point cloud can be associated with some attributes, depending on the applications. For example, for VR/AR/Gaming, the attribute includes color (r, g, b); and for LiDAR, the attribute includes reflectance.

### Point Cloud Data Use Cases

The automotive industry and autonomous car are domains in which point clouds may be used. Autonomous cars should be able to “probe” their environment to make good driving decisions based on the reality of their immediate surroundings. Typical sensors like LiDARs produce (dynamic) point clouds that are used by the perception engine. These point clouds are not intended to be viewed by human eyes and they are typically sparse, not necessarily colored, and dynamic with a high frequency of capture. They may have other attributes like the reflectance ratio provided by the LiDAR as this attribute is indicative of the material of the sensed object and may help in making a decision.

Virtual Reality (VR) and immersive worlds have become a hot topic and foreseen by many as the future of 2D flat video. The basic idea is to immerse the viewer in an environment all around the viewer as opposed to standard TV where the viewer can only look at the virtual world in front of the viewer. There are several gradations in the immersivity depending on the freedom of the viewer in the environment. Point cloud is a good format candidate to distribute VR worlds. They may be static or dynamic and are typically of average size, say no more than millions of points at a time.

Point clouds may also be used for various purposes such as culture heritage/buildings in which objects like statues or buildings are scanned in 3D to share the spatial configuration of the object without sending or visiting it. Also, it is a way to ensure preserving the knowledge of the object in case it may be destroyed, for instance, a temple by an earthquake. Such point clouds are typically static, colored, and huge.

Another use case is in topography and cartography in which using 3D representations, maps are not limited to the plane and may include the relief. Google Maps is now a good example of 3D maps but uses meshes instead of point clouds. Nevertheless, point clouds may be a suitable data format for 3D maps and such point clouds are typically static, colored, and huge.

World modeling and sensing via point clouds could be an essential technology to allow machines to gain knowledge about the 3D world around them, which is crucial for the applications discussed above.

3D point cloud data are essentially discrete samples on the surfaces of objects or scenes. To fully represent the real world with point samples, in practice it requires a huge number of points. For instance, a typical VR immersive scene contains millions of points, while point clouds typically contain hundreds of millions of points. Therefore, the processing of such large-scale point clouds is computationally expensive, especially for consumer devices, e.g., smartphone, tablet, and automotive navigation system, that have limited computational power.

The first step for any processing or inference on the point cloud is to have efficient storage methodologies. To store and process the input point cloud with affordable computational cost, one solution is to down-sample it first, where the down-sampled point cloud summarizes the geometry of the input point cloud while having much fewer points. The down-sampled point cloud is then fed to the subsequent machine task for further consumption. However, further reduction in storage space can be achieved by converting the raw point cloud data (original or down sampled) into a bitstream through entropy coding techniques for lossless compression.

In addition to lossless coding, many scenarios seek for lossy coding for significantly improved compression ratio while maintaining the induced distortion under certain quality levels. To achieve a less lossy coding, an efficient point feature extractor is necessary to improve the accuracy of the reconstruction within the given resource budget.

### Learning-Based Point Cloud Compression

Since point cloud data is composed of two components: geometry information and attribute information, the compression of point clouds can be classified into two categories: geometry coding and attribute coding. This work is focused on attribute coding and assumes that the geometry information of the point cloud is already coded and available at both encoder and decoder.

Examples of existing learning-based point cloud attribute compression techniques are deep octree-based (lossless) attribute compression and end-to-end feature-based attribute coding. With deep octree-based attribute compression, neural network-based models are utilized to estimate the discrete probability distribution of the attribute values. Such estimated probabilities are then used to help the arithmetic coder to encode or decode the attribute value(s) associated with that particular point. This work is about learning-based lossless point cloud attribute compression.

We first describe a traditional point cloud attribute compression system, then describe the point cloud attribute compression system introduced in the '402 application. In both of these two compression systems, they use the same way to perform the probability estimation, as well as the arithmetic coding after the probability estimation.

All learning-based methods for octree-based attribute coding before the proposal of the '402 application depend solely on octree voxel attribute information from parent levels, or from sibling nodes at current level. This constitutes a top-down strategy.

With such learning-based methods, the encoder and decoder both conduct the probability estimation procedure using exactly the same method that can even be non-learning-based. The only interface between their encoder and decoder is the arithmetic coded attribute information.

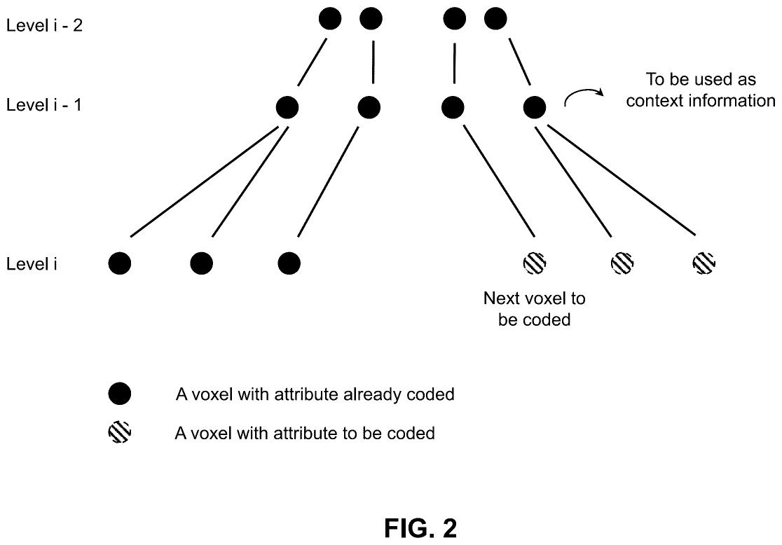

FIG. 2 illustrates a portion (level i−2, i−1, i) of an octree to be coded. In FIG. 2, we use a binary tree representing an octree for a point cloud only for the purpose of simplify the drawing. A solid point represents an occupied octree voxel with attributes, that have been already encoded or decoded, while a circle with shading represents the octree voxels with attributes to be encoded or decoded.

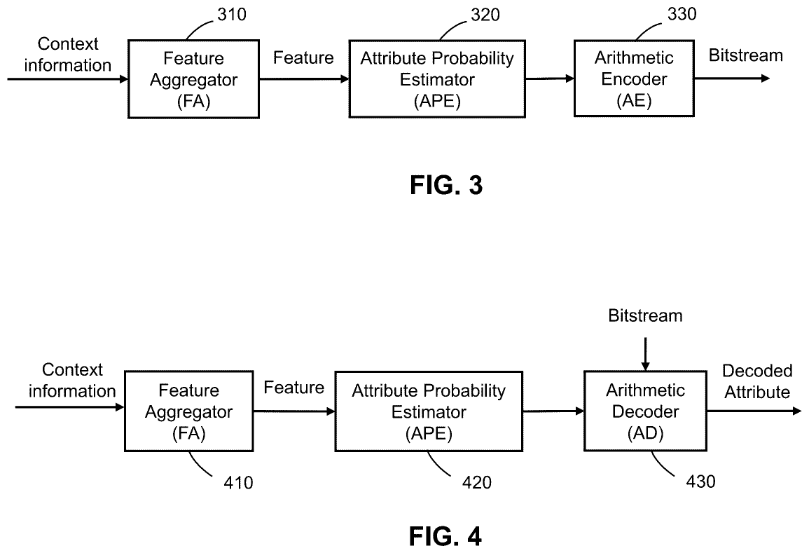

FIG. 3 and FIG. 4 illustrate an example of such top-down methods for octree-based attribute encoding and decoding, respectively. On the encoder side, the encoder conducts feature extraction/aggregation (310). A neural network model FA is deployed here for the feature extraction/aggregation. Its input is composed of at least the context information, for example, that indicates the attributes information of voxels in its parent level. Note that no information from finer level of details will be used. Different methods utilize different neural network models to do the feature extraction/aggregation.

The encoder estimates the attribute probability distribution of an octree voxel. This is achieved by another neural network model APE (attribute probability estimator, 320). The encoder performs arithmetic encoding AE (330) according to the actual attribute values of a current octree voxel based on the estimated probability.

On the decoder side, the decoder also performs feature aggregation (410) and attribute probability estimation (420) as the encoder. The corresponding arithmetic decoding AD (430) is performed to lossless decode the attribute value of the corresponding octree voxel.

It should be noted here again that for attribute coding the geometry is already known for both the encoder and decoder, and only the attribute information is coded.

### Encoding

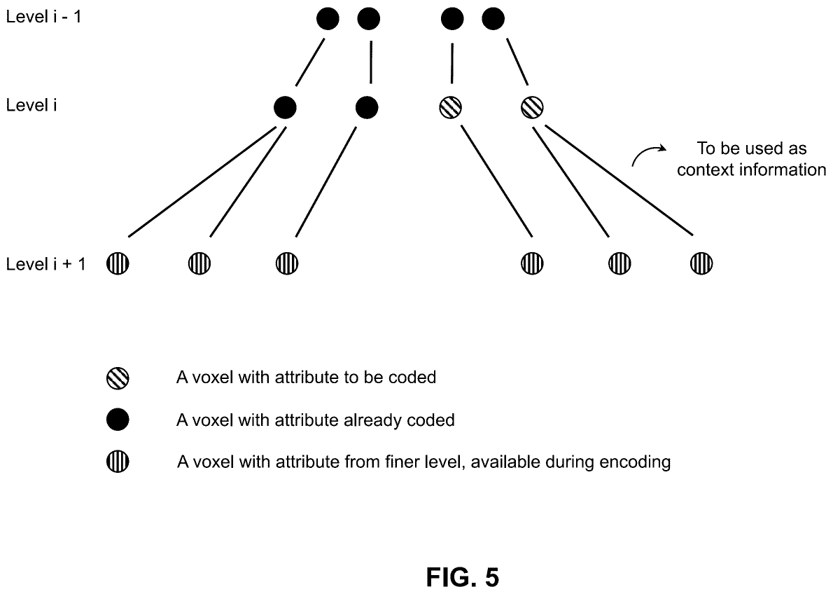

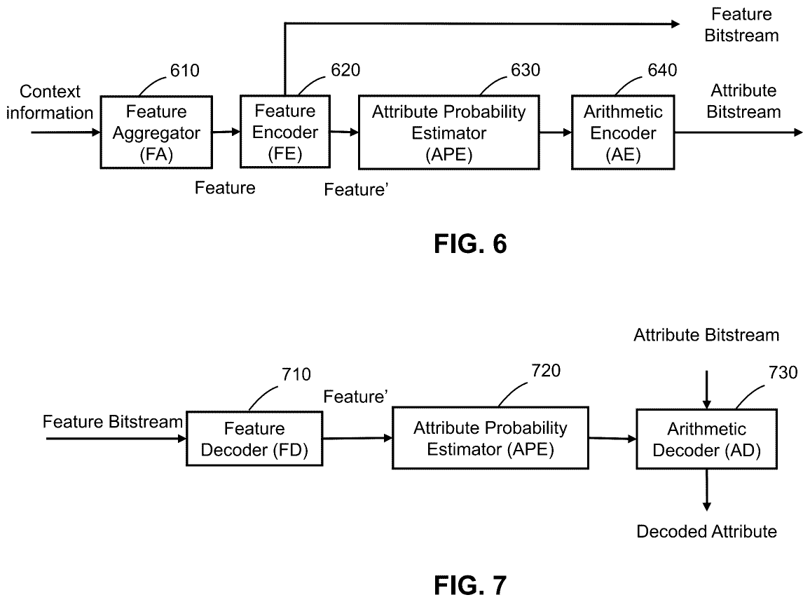

FIG. 5 illustrates a portion (level i−1, i, i+1) of the octree to be coded. The encoding method of the '402 application is illustrated in FIG. 6.

Unlike the feature extractor in prior-art method where the input is from its parent level and maybe from the current level in addition, the proposed feature extractor/aggregator (610) uses the finer (child) level of details as its input. Because the finer level of voxels always has more detailed information comparing to voxels from a parent level, it is much easier to extract more representative features.

The generated features generated are encoded (620) into bitstreams. In addition to generating the bitstream, the feature encoder also outputs the reconstructed feature (Feature′), that may not be exactly the same as the feature (Feature) from the feature extractor/aggregator (610). In one embodiment, the reconstructed feature is a quantized/dequantized version of the feature from the feature extractor/aggregator (610). The reconstructed feature should match the decoded feature on a decoder.

The attribute probability estimator (APE, 630) uses a neural network model. It takes the reconstructed feature as its input and computes the attribute probability distribution of a current octree voxel.

Based on the estimated probability, the arithmetic encoder (640) will encode the attribute information of the current octree voxels into a bitstream.

### Decoding

The decoding method of the '402 application corresponding to the encoding method is illustrated in FIG. 7.

In particular, a feature decoder (FD, 710) decodes a feature from the input bitstream. This is different from methods before the '402 application. In previous methods, the decoding starts with a feature extractor. In the decoder of the '402 application, it begins with a feature decoder. Basically, the decoder relies on a coded feature rather than to extract the feature from scratch by itself. The decoder benefits from a more representative feature as the features were extracted using fine level of details than from the parent level as in the previous methods.

The attribute probability estimator (APE, 720)) is the same as the APE (630) on the encoder side as illustrated in FIG. 6. It computes an attribute probability of a next octree voxel. Based on the estimated probability, the arithmetic decoder (AD, 730) will determine the attribute values of the next octree voxel.

### Feature Aggregator FA

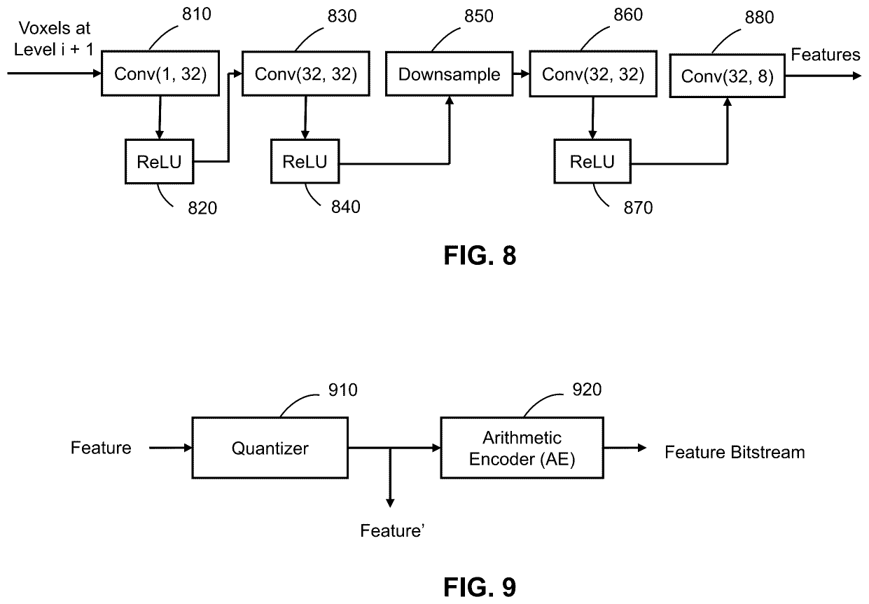

An example design of the feature aggregator (FA) is shown in FIG. 8. In this case, the feature extractor just takes the immediate next level of voxel with attributes as input to extract features.

In this design of the feature aggregator (FA), it is composed of several 3D convolutional layers (with downsample), i.e., the “Conv” blocks (810, 830, 850, 860, 880) in FIG. 8, where Conv (x, y) means the input feature channel size is x while the output feature channel size is y. All the convolutional layers, except for the last one, are appended by a ReLU activation function (820, 840, 870) to introduce non-linearity to the feature aggregation process. The “Downsample” block (850) is to downsample the feature from (i+1)-th to the i-th level. In more advanced embodiments, the convolutional layers can be replaced with other commonly used feature aggregation blocks, such as an Inception ResNet (IRN) block, and a Voxel Transformer block, and these blocks can be repeated several times to enhance the feature aggregation performance. The input to the FA module can be the voxelized point cloud with attribute information associated with it, for RGB color attribute, the input channel size can be 3; while for reflectance in LiDAR point cloud, the input channel size can be 1.

### Feature Encoder FE

The feature encoder FE can be implemented in various ways. In this design, a proposed feature encoder is shown in FIG. 9. At 910, the feature is quantized based on a quantization step. The selection of quantization step is out of the scope of this work, but in a nutshell, it is a pre-selected parameter based on rate distortion requirement. At 920, the quantized feature is arithmetically encoded into a feature bitstream.

### Feature Decoder FD

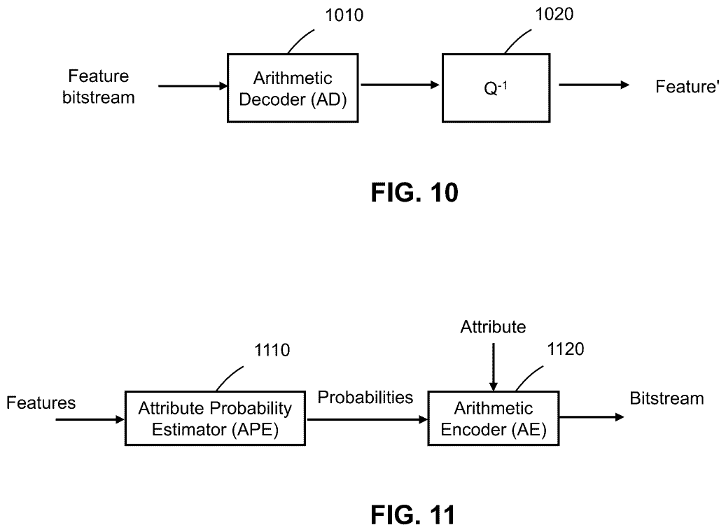

A feature decoder design is shown in FIG. 10. This is the corresponding decoding of the encoder as shown in FIG. 9. Firstly, the input bitstream is arithmetically decoded (1010). Next, dequantization (1020) is conducted to output the decoded features.

### Probability Estimation and Coding

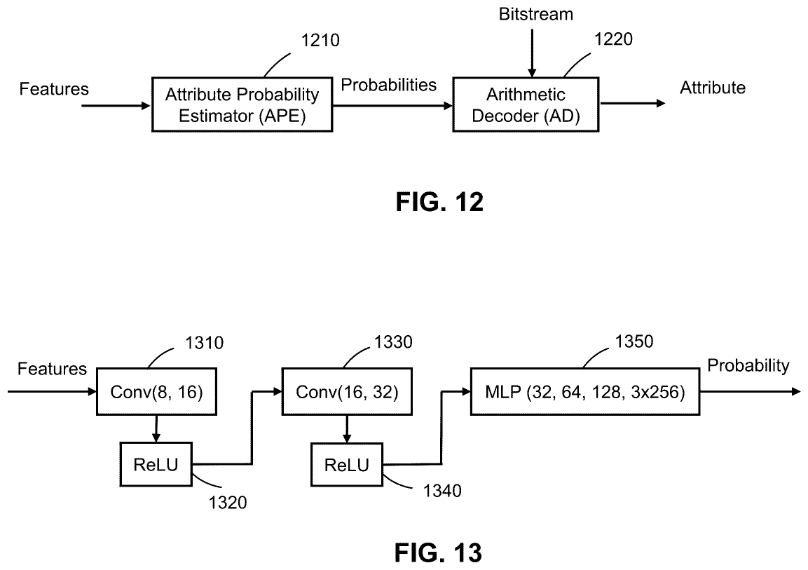

For both the compression system of FIG. 3 and FIG. 4 (the traditional method) and the design of the '402 application (FIG. 6 and FIG. 7), they have the same probability estimation process and the same arithmetic coding process. For illustration, the probability estimation, followed by arithmetic coding, are shown in FIG. 11 for encoder and FIG. 12 for decoder for discussion.

On the encoder side, the features-either obtained from previously encoded information as of FIG. 3, or from finer-level information as of the '402 application in FIG. 6—are fed to the attribute probability estimator APE (1110), then the probabilities output by APE is further fed to the arithmetic encoder (1120) to assist the coding of attribute into bitstream.

On the decoder side, the features-either obtained from previously decoded information, e.g., with the design of the traditional method shown in FIG. 4, or from the finer-level information such as the design of the '402 application in FIG. 7—are fed to the attribute probability estimator APE (1210), then the probabilities output by APE is further fed to the arithmetic decoder (1220) to assist the decoding of attribute from the bitstream.

The design of the APE is provided in FIG. 13. Firstly, the feature is further aggregated/refined by a few convolutional layers (two Conv layers in the example of FIG. 13, 1310, 1330), where a ReLU activation function (1320, 1340) is appended after each Conv layer to introduce non-linearity. After that, it is passed to a multilayer perceptron (MLP, 1350) to finally compute the probability. In FIG. 13, the array (32, 64, 128, 3×256) after MLP indicates the channel size of the MLP layers. In the end, the attribute probability distribution is a (3×256)-dimensional vector, which corresponds to probabilities of the integer values in range [0, 255] for the attribute RGB channels. Notice that here we assume the bit depth of the image is 8, therefore the largest achievable value is 255 for each color channel. In general, for the case that bit depth equals b, the largest achievable value should be 2^{b}−1. In the case of reflectance attribute for LiDAR point cloud, the MLP output can be a 100-dimensional vector assuming there are 100 different reflectance intensities level in [0, 99] to be considered.

In this design, the probabilities of each of the 256 classes (values) in the range [0, 255] are estimated separately. In practice, the probabilities of class i and its neighboring classes, e.g., class i−1 and i+1, should be similar. However, in the design of FIGS. 11-139, this inter-class correlation of the probability values is not considered, leading to suboptimal probability estimation and hence suboptimal compression performance. This is the problem to be resolved in this work.

In one embodiment, instead of letting the neural network (FIG. 13) directly output the probability values of each class, we propose to let the neural network output the probability distribution parameters of a predefined distribution. After that, based on the probability distribution parameters, the probability values can be determined by, e.g., integrating the intervals of each attribute class. Therefore, in our proposal, the probabilities between neighboring classes become more correlated because they are now parameterized by a (continuous) probability density function.

### Encoder

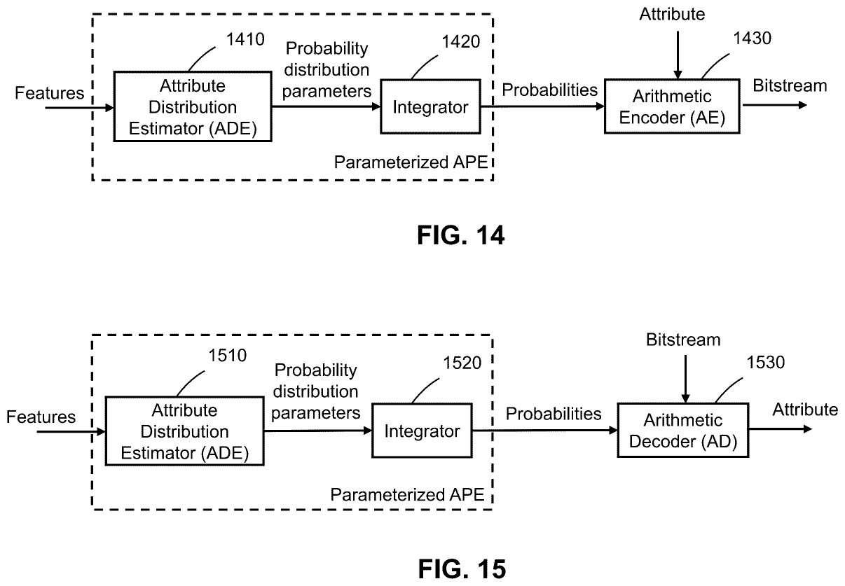

The design of our work is provided in FIG. 14 for encoder and FIG. 15 for decoder, according to one embodiment. On the encoder side, given the features—either obtained from previously encoded information as illustrated in FIG. 3, or from finer-level information as illustrated in FIG. 6 of the '402 application—they are fed to an attribute distribution estimator (ADE, 1410) module. In this proposal, we assume that the probabilities of a voxel belonging to a certain class follows a predefined probability distribution. With this assumption, the ADE module outputs the probability distribution parameters, rather than outputting the probability values directly in APE.

In one embodiment, the predefined probability distribution is the Gaussian distribution. In another embodiment, the probability distribution is the Laplace distribution. In the case of Gaussian distribution, the probability distribution parameters to be estimated by the ADE include both the mean and the variance. In the case of Laplace distribution, the probability distribution parameters to be estimated include the mean and the scale parameter. Then in both cases, for each voxel with an attribute value to be encoded, the ADE module outputs two (2) numbers, one for each distribution parameter. Other probability distributions can also be used, suppose a probability distribution has k parameters, then the ADE output k numbers to describe the probability density function.

We note that the selection of the probability distribution comes from, for example, the prior knowledge about the contents to be coded. In practice, one may try out different distributions and see which one provides better coding performance. Additionally, the selection of the probability distribution affects the neural network parameters via training. Therefore, once the probability distribution is chosen and the neural network is trained, the encoder and decoder must keep using the selected probability distribution and cannot be changed. Also note that our work is not limited to only choosing the Gaussian distribution or the Laplace distribution. Other distributions, e.g., the gamma distribution, can also be used in practice.

For instance, for a color point cloud (with RGB) with N voxels, the ADE takes as input a feature map with dimension N×D where D is the channel size of the feature. ADE outputs a tensor with all the distribution parameters of dimension N×3×2, where for each color (R, G and B) of each voxel, it has two (2) numbers—the mean value and the variance (assuming Gaussian distribution is used). With these two distribution parameters, it is sufficient to describe the probabilities of all the classes (ranging from 0 to 255 for the case of RGB color). The ADE module is a learning-based module similar to the APE module. The design of the ADE module will be discussed later.

Having obtained the probability distribution parameters for all the voxels, an Integrator module (1420) is applied to convert the continuous probability density function generated by ADE to a probability mass function. Particularly, based on the pre-selected distribution (e.g., Gaussian distribution), and the probability distribution parameters (e.g., means and the variances for Gaussian distribution) output by ADE, it computes the probability that an attribute (e.g., R channel) of a voxel belongs to a class (e.g., from 0 to 255). The output of the Integrator module is a tensor with dimension N×3×256. It contains all the probability values for the arithmetic encoder (AE, 1430) to encode the N×3 input attribute values.

Next, the probabilities are fed to the AE module (1430), and the AE module (1430) encodes the attribute values with the assistance of the probabilities, leading to the output bitstream.

### Decoder

On the decoder side, the design is similar to the encoder. Again, the ADE module (1510) is applied to estimate the probability distribution parameters based on the features. Note that the features fed to ADE here should be the same as the input features to the ADE (1410) of the encoder. After that, the estimated probability distribution parameters are fed to the Integrator module (1520) to compute the discrete probability values. In the end, the arithmetic decoder (AD, 1530) is applied to decode the bitstream to the attribute value, with the assistance of the probability values.

Note that in our design, the ADE and the Integrator together forms a new attribute probability estimator. In our work, we call the combination of the ADE and the Integrator as the Parameterized APE. It differs from the earlier APE in FIG. 11 and FIG. 12 in that, the Parameterized APE estimates the distribution parameter(s) first instead of estimating the probability values directly.

### Attribute Distribution Estimator (ADE)

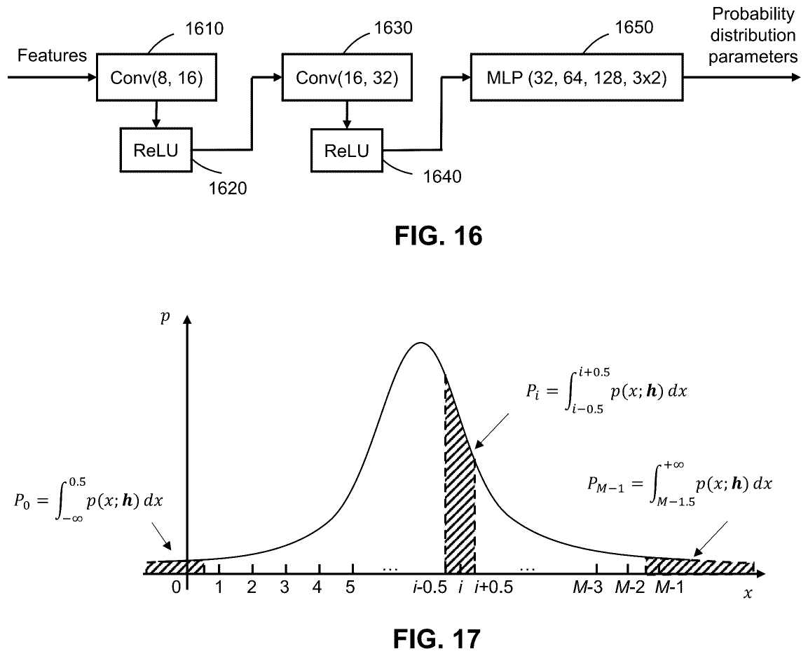

According to one embodiment, the design of the ADE is provided in FIG. 16 which is very similar to that of the APE. Firstly, the feature vectors are aggregated/refined by a few convolutional layers (two Conv layers in the example of FIG. 16, 1610, 1630), where a ReLU activation function (1620, 1640) is appended after each Conv layer to introduce non-linearity. After that, it is passed to a multilayer perceptron (MLP, 1650) to finally compute the probability distribution parameters. In FIG. 16, the array (32, 64, 128, 3×2) after MLP indicates the channel size of the MLP layers for the example of RGB color attribute. In the end, the attribute probability distribution is a (3×2)-dimensional vector for each voxel, which corresponds to the distribution parameters of the R channel, the G channel, and the B channel, respectively. We note that our work is not restricted to the RGB color space. Other color space, such as YUV and YCbCr can also be used with our proposal. In the case of reflectance attribute for LiDAR point cloud, the MLP output can be a 2-dimensional vector because the reflectance contains only one channel.

### Integrator

To compute the probabilities for an attribute of a voxel with M possible classes (e.g., 256 classes for color), the integrator computes the integral of each classes given the probability distribution parameters.

Suppose we are focusing on the coding of a voxel having an attribute with M classes, and the probability distribution parameters of the voxel are organized in a vector h, then the Integrator module computes the following probabilities:

$${P}_{i} = {\int }_{i - 0.5}^{i + 0.5} p ( x ; h ) dx$$

for all the i in {1, 2, . . . , M−2}. We additionally define

$${P}_{0} = {\int }_{- ∞}^{0.5} p ( x ; h ) dx and {P}_{M - 1} = {\int }_{M - 1.5}^{+ ∞} p ( x ; h ) dx ,$$

so that it is guaranteed that

$${\sum }_{i = 0}^{M - 1} {P}_{i} = 1 ,$$

i.e., all the computed probabilities sum up to be 1. This process of integrating a probability density function to obtain the probability values is illustrated in FIG. 17.

In the embodiment assuming the probabilities follow Gaussian distributions, the function p(·) takes the functional form of the probability density function of Gaussian distribution, i.e.,

$$p ( x ; μ , {σ}^{2} ) = \frac{1}{\sqrt{2 π {σ}^{2}}} exp ( - \frac{{( x - μ )}^{2}}{2 {σ}^{2}} )$$

$$and h = [ μ σ ] .$$

In the embodiment assuming the probabilities follow Laplace distribution, p(·) takes the functional form of the probability density function of Laplace distribution, i.e.,

$$p ( x ; μ , b ) = \frac{1}{2 b} exp ( - \frac{\vert x - μ \vert}{b} )$$

$$and h = [ μ b ] .$$

At the end, for an attribute value to be coded, a vector [P₀ P₁ P₂ . . . P_{M-1}] is produced by the Integrator. Thus, for example, for a point cloud with N voxels where each voxel has 3 colors (RGB), the Integrator generates a tensor of size N×3×256. In another embodiment where each voxel has a reflectance value ranging from 0 to 99, the Integrator generates a tensor of size N×100.

To apply this design in the traditional attribute coding system (FIG. 3 and FIG. 4) and the attribute coding proposed in the '402 application (FIG. 6 and FIG. 7), we directly replace the APE modules in FIG. 3, FIG. 4, FIG. 6 and FIG. 7 with the Parameterized APE in FIG. 14 or FIG. 15.

Our proposal can be applied for the lossless coding of different attribute types. We hereby provide a few use cases. In an embodiment, it is applied to the coding of reflectance of LiDAR point clouds. In another embodiment, it is applied to the coding of color attribute in the RGB color space. In another embodiment, it is applied to the coding of color attribute in the YUV color space. In yet another embodiment, it is applied to the coding of normal attribute.

In another embodiment, when the output of ADE (FIG. 16) contains a distribution parameter that should be larger than 0, e.g., variance of Gaussian distribution or scale parameter of Laplace distribution, we propose a simple way to convert the direct output of the neural network to another real number that is larger than 0. This can be very useful because the direct output of the neural network can be negative while it is impossible for the variance or the scale parameter to be negative. Suppose the output by the neural network of the ADE is x, in this embodiment, we use the following function c(x) to map x to a real number x′ that is always larger than 0:

$${x}^{′} = c ( x ) = \{ \begin{matrix}x + 1 , & x > 0 \\ exp ( x ) , & x \leq 0\end{matrix}$$

This function c(x) is smooth at x=0, so it can make the neural network training more effective compared to popular activation functions such as the ReLU function. To apply this function c(x), in an embodiment, it is appended after the MLP (1650) in FIG. 16. In this case, rather than treating the direct output of the MLP (1650) as the distribution parameters, the outputs of the c(x) function are the distribution parameters to be fed to the integrator (1420 in FIG. 14, or 1520 in FIG. 15).

One or more embodiments provide a computer program comprising instructions which when executed by one or more processors cause such processors to perform the encoding and/or decoding methods according to any of the embodiments described above. One or more embodiments also provide a computer readable storage medium having stored thereon instructions for encoding or decoding point cloud data according to the methods described above.

One or more embodiments provide a computer readable storage medium having stored thereon point cloud data generated according to the methods described above. One or more embodiments also provide a method and apparatus for transmitting or receiving point cloud data generated according to the methods described above.

The embodiments described herein may be implemented in, for example, a method or a process, an apparatus, a software program, a data stream, or a signal. Even if only discussed in the context of a single form of implementation (e.g., as a method), the implementation of such features may also be implemented in other forms. An apparatus may be implemented in, for example, appropriate hardware, software, and firmware. Corresponding methods may be implemented in, for example, a processor.

Various numeric values are used in the present application. Such specific values are for example purposes and the embodiments described are not limited to these specific values.

Various methods are described herein, and such methods comprise one or more steps or actions for achieving the described method. Unless a specific order of steps or actions is required for the proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an order to the operations unless specifically required.

The present disclosure may refer to “determining” various pieces of information. Determining information may include one or more of, for example, estimating, calculating, predicting, or retrieving (e.g., from memory) the information.

The present disclosure may refer to “accessing” various pieces of information. Accessing information may include one or more of, for example, receiving, retrieving (e.g., from memory), storing, moving, copying, calculating, determining, predicting, or estimating the information. Similarly, the present disclosure may refer to “receiving” various pieces of information. Receiving information may include one or more of, for example, accessing or retrieving (e.g., from memory) the information.

It is to be understood that use of any of the following “/”, “and/or”, and “at least one of” is intended to encompass all possible selections of listed items, taken either individually or in any combination thereof.

While specific embodiments have been described in the foregoing description in connection with the accompanying drawings, it should be understood that embodiments described herein are examples only and should not be taken as limiting the scope of the present disclosure or the following claims. Although features and elements are described herein in particular combinations, those of ordinary skill in the art will appreciate that such features or elements may be used alone or in any combination with the other features and elements. It is understood, therefore, that the overall teachings of the present disclosure are not limited to the particular embodiments, implementations, and examples disclosed herein, but are intended to cover variations, modifications, and alternatives as defined by the appended claims and any and all equivalents thereof.

1. A method of decoding point cloud data, comprising:
obtaining a feature map representing attributes of voxels in an octree structure;
determining one or more probability distribution parameters for a probability density function associated with an attribute of a current voxel, based on the feature map;
determining a probability mass function of the attribute of the current voxel based on the one or more probability distribution parameters for the probability density function for the current voxel; and
decoding attribute information of the current voxel in the octree structure, based on the probability mass function of the attribute for the current voxel.

2. The method of claim 1, wherein the determining one or more probability distribution parameters for a probability density function is based on a neural network.

3. The method of claim 2, wherein the neural network includes at least one or more convolutional layers and a multilayer perceptron layer.

4. The method of claim 3, wherein the neural network further performs non-linear mapping to convert an output of the multilayer perceptron layer to a value that is always positive.

5. The method of claim 1, wherein the determining a probability mass function of the attribute of the current voxel comprises obtaining an integral for each class of the probability density function to obtain the probability mass function.

6. The method of claim 1, wherein the probability density function is a Gaussian distribution function or a Laplace distribution function.

7. A method of encoding point cloud data, comprising:
obtaining a feature map representing attributes of voxels in an octree structure;
determining one or more probability distribution parameters for a probability density function associated with an attribute of a current voxel, based on the feature map;
determining a probability mass function of the attribute of the current voxel based on the one or more probability distribution parameters for the probability density function for the current voxel; and
encoding attribute information of the current voxel in the octree structure, based on the probability mass function of the attribute for the current voxel.

8. The method of claim 7, wherein the determining one or more probability distribution parameters for a probability density function is based on a neural network.

9. The method of claim 8, wherein the neural network includes at least one or more convolutional layers and a multilayer perceptron layer.

10. The method of claim 9, wherein the neural network further performs non-linear mapping to convert an output of the multilayer perceptron layer to a value that is always positive.

11. The method of claim 7, wherein the determining a probability mass function of the attribute of the current voxel comprises obtaining an integral for each class of the probability density function to obtain the probability mass function.

12. The method of claim 7, wherein the probability density function is a Gaussian distribution function or a Laplace distribution function.

13. An apparatus for decoding point cloud data, comprising one or more processors and at least one memory coupled to the one or more processors, wherein the one or more processors are configured to:
obtain a feature map representing attributes of voxels in an octree structure;
determine one or more probability distribution parameters for a probability density function associated with an attribute of a current voxel, based on the feature map;
determine a probability mass function of the attribute of the current voxel based on the one or more probability distribution parameters for the probability density function for the current voxel; and
decode attribute information of the current voxel in the octree structure, based on the probability mass function of the attribute for the current voxel.

14. The apparatus of claim 13, wherein the determining one or more probability distribution parameters for a probability density function is based on a neural network.

15. The apparatus of claim 14, wherein the neural network includes at least one or more convolutional layers and a multilayer perceptron layer.

16. The apparatus of claim 15, wherein the neural network further performs non-linear mapping to convert an output of the multilayer perceptron layer to a value that is always positive.

17. An apparatus for encoding point cloud data, comprising one or more processors and at least one memory coupled to the one or more processors, wherein the one or more processors are configured to:
obtain a feature map representing attributes of voxels in an octree structure;
determine one or more probability distribution parameters for a probability density function associated with an attribute of a current voxel, based on the feature map;
determine a probability mass function of the attribute of the current voxel based on the one or more probability distribution parameters for the probability density function for the current voxel; and
encode attribute information of the current voxel in the octree structure, based on the probability mass function of the attribute for the current voxel.

18. The apparatus of claim 17, wherein the determining one or more probability distribution parameters for a probability density function is based on a neural network.

19. The apparatus of claim 18, wherein the neural network includes at least one or more convolutional layers and a multilayer perceptron layer.

20. The apparatus of claim 19, wherein the neural network further performs non-linear mapping to convert an output of the multilayer perceptron layer to a value that is always positive.
